(19) United States
(12) Patent Application Publication
(10) Pub. No.: US 2025/0114919 A1
(43) Pub. Date: Apr. 10, 2025

(54) WRENCH SUITABLE FOR NARROW AND SMALL SPACE

(71) Applicant: LAB (XIAMEN) SANITARY FITTINGS INC., Xiamen (CN)

(72) Inventor: Yongmao LIU, Xiamen (CN)

(21) Appl. No.: 18/432,370

(22) Filed: Feb. 5, 2024

(30) Foreign Application Priority Data
Oct. 10, 2023 (CN) 202322710292.5

(51) Int. Cl. B25B 13/48

(52) U.S. Cl. CPC B25B 13/481

(57) ABSTRACT

A wrench suitable for a narrow and small space includes a handle, a socket wrench head, and a clamping part, where the socket wrench head is arranged at one end of the handle, and an inner cavity for mounting a nut and a bolt reservation hole communicating with the inner cavity are provided inside the socket wrench head; and the clamping part for clamping a gasket is arranged at the other end of the handle. According to the present disclosure, the gasket is clamped by the clamping part of the wrench instead of fingers, such that the operation is more flexible, and both the operation and the line of sight are not restricted by the size of a mounting hole. Therefore, the wrench is suitable for mounting a toilet and other products with narrow and small spaces conveniently and quickly.

### CROSS-REFERENCE TO RELATED APPLICATIONS

This application claims priority to Chinese Patent Application 202322710292.5, filed on Oct. 10, 2023, which is incorporated herein by reference.

### TECHNICAL FIELD

The present disclosure relates to the technical field of wrenches, in particular to a wrench suitable for a narrow and small space.

### BACKGROUND

Existing various products are usually mounted by bolts, and some products are difficult to mount due to narrow and small spaces. For example, toilets are mounted by anchor bolts. As shown in FIG. 1, in the prior art, when a toilet 1′ is mounted, a bolt mounting hole usually provided in the bottom surface of the toilet is aligned with an anchor bolt (hereinafter referred to as a bolt) on a floor (or the ground), the toilet is placed on the floor, the bolt penetrates through the bolt mounting hole, and a gasket and a nut are mounted to lock the bolt and the toilet. Because the sealing and aesthetic requirements for the inside of the toilet need to be met, a small mounting hole 11′ is generally provided in only the lower part of the side edge of the toilet to mount a gasket 3′ and a nut 4′. During mounting, the gasket needs to be first clamped by fingers to penetrate through the mounting hole and is driven to extend into the toilet, the gasket is sleeved on the bolt, and then the nut is mounted by a wrench as shown in FIG. 2. A socket wrench head is arranged at one end of the wrench, and an inner cavity for placing the nut and a bolt reservation hole communicating with the inner cavity are provided in the socket wrench head. When the nut is sleeved, the nut is first placed into the inner cavity of the socket wrench head, then the other end of the wrench is grasped, the socket wrench head of the wrench extends into the toilet, the bolt is sleeved with the nut, and finally the nut is tightened with the wrench to complete the mounting of the toilet.

When the toilet is mounted by the above method, the movement of the fingers after clamping the gasket to penetrate through the mounting hole is restricted as the mounting hole is small, and the line of sight will be blocked by a hand due to being restricted by the size of the mounting hole, such that the gasket cannot be quickly and accurately sleeved on the bolt. Therefore, the existing method for mounting the toilet by the bolt is very inconvenient for mounting the gasket and cannot quickly complete the mounting of the toilet.

### SUMMARY

An objective of the present disclosure is to provide a wrench suitable for a narrow and small space, to solve the problem that a gasket is inconvenient to mount in the background.

To achieve the above objective, the present disclosure adopts the following solution: a wrench suitable for a narrow and small space includes a handle and a socket wrench head, where the socket wrench head is arranged at one end of the handle, and an inner cavity for mounting a nut and a bolt reservation hole communicating with the inner cavity are provided inside the socket wrench head; and a clamping part for clamping a gasket is arranged at the other end of the handle.

Further, the clamping part is a strip-shaped clamp gap provided at the other end of the handle, and a left clamping arm and a right clamping arm are formed on two sides of the clamp gap.

Further, a bulge for increasing a clamping force is convexly arranged on a clamping surface of the left clamping arm or the right clamping arm.

Further, a width of the clamp gap is the same as a thickness of the gasket.

Further, the left clamping arm and the right clamping arm are made of an elastic material, and the width of the clamp gap is smaller than the thickness of the gasket.

Further, the inner cavity of the socket wrench head is a quincuncial socket hole.

Further, the handle and the socket wrench head are perpendicular to each other in a corner shape.

Further, the wrench is made of stainless steel or plastics.

With the above solution, the present disclosure has the following beneficial effects:

According to the present disclosure, the clamping part for clamping the gasket is arranged at the other end of the handle, such that the gasket can be clamped by the clamping part when mounted. There is provided an example where a toilet is mounted. After the gasket is tightly clamped by the clamping part, one end or the middle of the handle is grasped, the clamping part penetrates through a mounting hole in a lower part of the toilet, and the gasket is driven to enter the toilet. In this process, the line of sight will not be blocked by a hand, and the position of a bolt can be seen clearly through the mounting hole, such that the gasket can be smoothly sleeved on the bolt. Then the nut is mounted by the socket wrench head of the wrench to fix the bolt of the toilet. According to the present disclosure, the gasket is clamped by the clamping part of the wrench instead of fingers, such that the operation is more flexible, and both the operation and the line of sight are not restricted by the size of the mounting hole. Therefore, the wrench is suitable for mounting the toilet and other products with narrow and small spaces conveniently and quickly.

### BRIEF DESCRIPTION OF DRAWINGS

FIG. 1 is a schematic diagram in which a gasket is clamped and mounted by fingers in the prior art;

FIG. 2 is a schematic diagram in which a nut is mounted in the prior art;

FIG. 3 is a first three-dimensional view of a wrench according to the present disclosure;

FIG. 4 is a partial enlarged view of A in FIG. 3;

FIG. 5 is a second three-dimensional view of a wrench according to the present disclosure;

FIG. 6 is a bottom view of a wrench according to the present disclosure;

FIG. 7 is a sectional view of a wrench according to the present disclosure;

FIG. 8 is a schematic diagram in which a gasket is mounted by a wrench according to the present disclosure;

FIG. 9 is a schematic diagram in which a gasket is sleeved on a bolt according to the present disclosure;

FIG. 10 is a schematic diagram in which a nut is mounted by a wrench according to the present disclosure;

FIG. 11 is a schematic diagram in which a nut is sleeved on a bolt according to the present disclosure;

FIG. 12 is a schematic diagram in which a wrench is taken up after a nut is sleeved according to the present disclosure;

FIG. 13 is a schematic diagram in which a nut is rotated with a finger according to the present disclosure;

FIG. 14 is a schematic diagram in which a nut is rotated to a lower part of a bolt according to the present disclosure;

FIG. 15 is a schematic diagram in which a socket wrench causes a bolt to penetrate through a bolt reservation hole according to the present disclosure;

FIG. 16 is a schematic diagram in which a nut is tightened with a wrench according to the present disclosure.

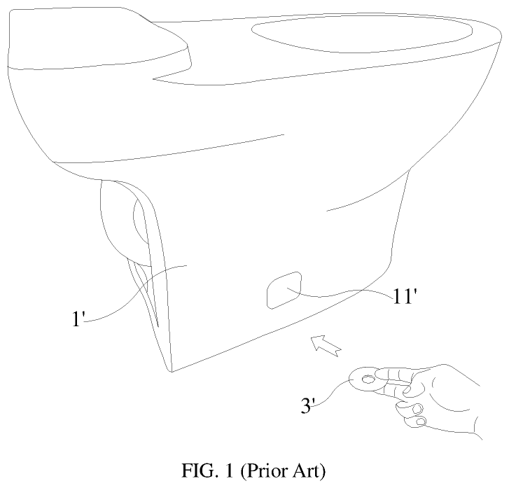

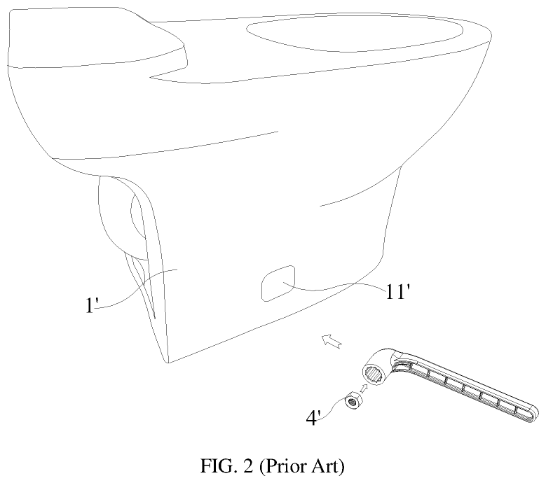

### DESCRIPTION OF REFERENCE NUMERALS

1. toilet; 11. mounting hole; 2. bolt; 3. gasket; 4. nut; 5. handle; 6. socket wrench head; 61. inner cavity; 62. bolt reservation hole; 7. clamping part; 71. clamp gap; 72. left clamping arm; 73. right clamping arm; and 74. bulge.

### DESCRIPTION OF EMBODIMENTS

The present disclosure is described in detail below with reference to the accompanying drawings and specific embodiments.

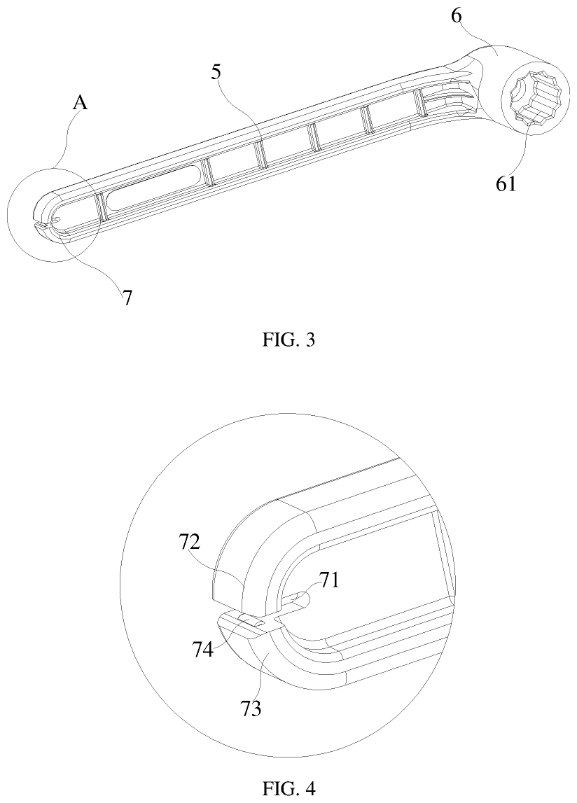

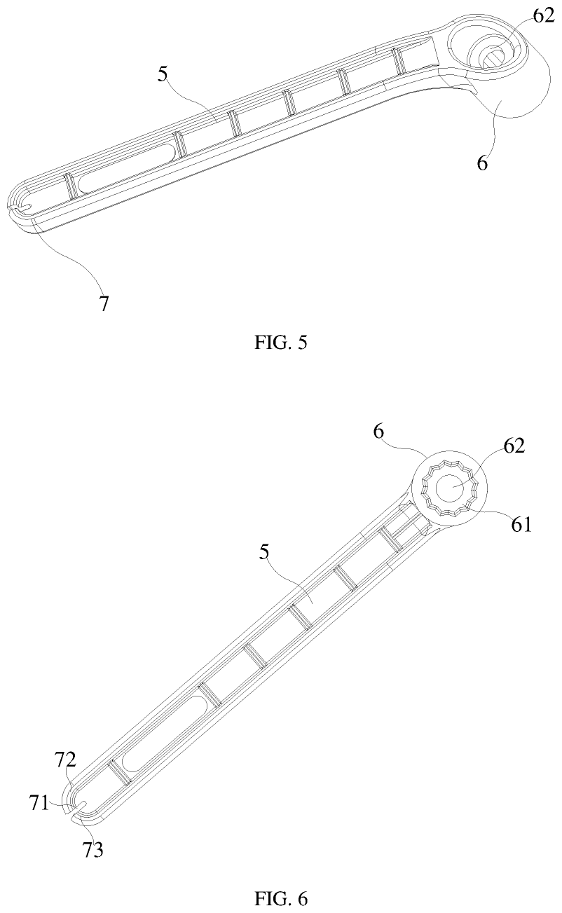

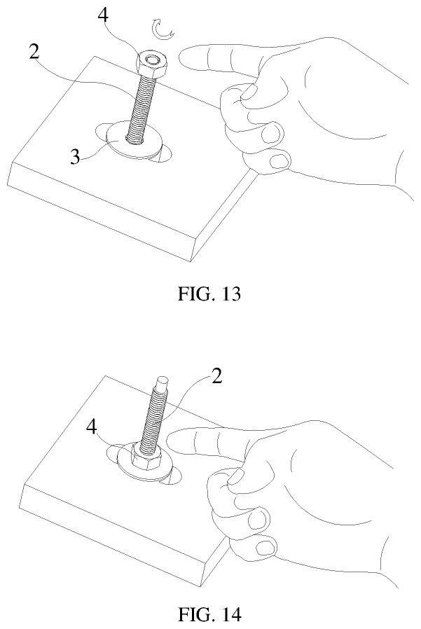

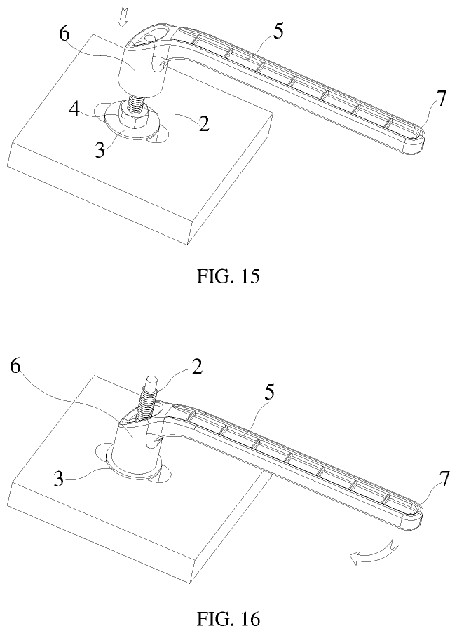

As shown in FIGS. 3 to 16, the present disclosure provides a wrench suitable for a narrow and small space, including a handle 5, a socket wrench head 6, and a clamping part 7, where the socket wrench head 6 is arranged at one end of the handle 5; an inner cavity 61 for mounting a nut 4 and a bolt reservation hole 62 communicating with the inner cavity 61 are provided inside the socket wrench head 6; the inner cavity 61 of the socket wrench head 6 may be a quincuncial socket hole, preferably a quincuncial twelve point socket hole, which has high adaptability and is suitable for various polygonal nuts; the bolt reservation hole 62 may be used for the bolt 2 to penetrate through when the nut 4 is screwed with the wrench and the bolt 2 is too long; and the clamping part 7 for clamping a gasket 3 is arranged at the other end of the handle 5.

Emphatically referring to FIGS. 3 to 7, the clamping part 7 may be a strip-shaped clamp gap 71 provided at the other end of the handle 5; the strip-shaped clamp gap 71 is preferably provided at a central axis of the other end of the handle 5; a left clamping arm 72 and a right clamping arm 73 are formed on two sides of the clamp gap 71; a width of the clamp gap 71 may be the same as a thickness of the gasket 3; the gasket 3 can be clamped by the left clamping arm 72 and the right clamping arm 73 after being inserted into the clamp gap 71; if the left clamping arm 72 and the right clamping arm 73 are made of an elastic material, the width of the clamp gap 71 may be slightly smaller than the thickness of the gasket 3; and the gasket 3 can be clamped more firmly through elastic matching between the left clamping arm 72 and the right clamping arm 73. Certainly, the clamping part 7 may also be another structure capable of clamping the gasket 3, such as a clamping jaw integrally or separately arranged at the other end of the handle 5. However, in the present disclosure, the clamp gap 71 is preferably provided. The clamp gap 71 is simple to process, saves materials, and does not increase the size of the wrench. The wrench as a whole may be set to be compact, which has the significant advantage for mounting the gasket 3 and the nut 4 through a mounting hole 11 in a lower part of a toilet 1.

As a preferred embodiment, a bulge 74 is convexly arranged on a clamping surface of the left clamping arm 72 or the right clamping arm 73. The bulge 74 is capable of increasing a force of friction with the gasket 3 to prevent the gasket 3 from falling off, so as to increase a clamping force of the clamping part 7.

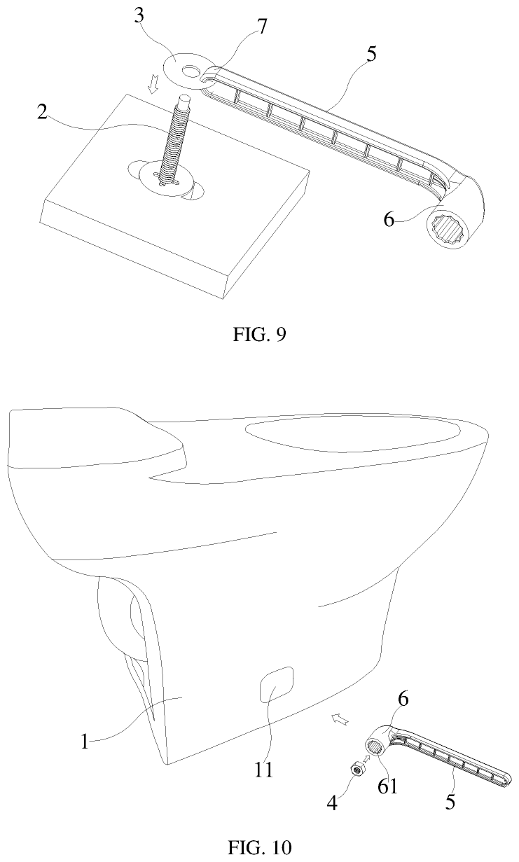

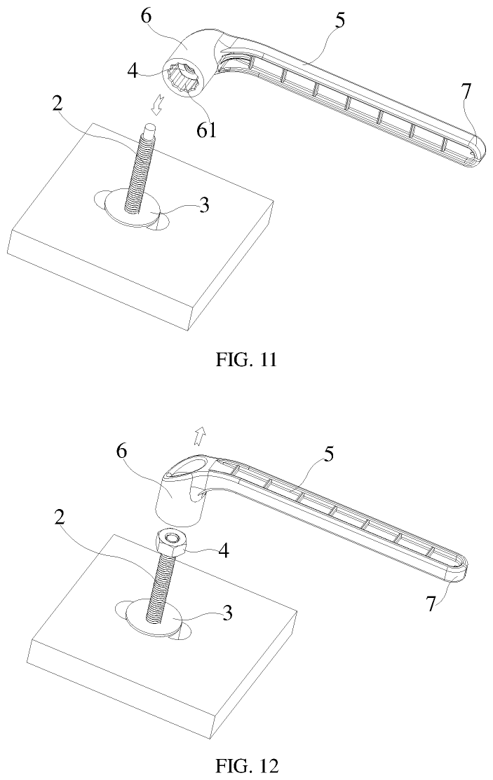

A process of mounting the toilet 1 with the wrench according to the present disclosure is as follows: first, the toilet 1 is placed on a floor, and the bolt 2 penetrates through a mounting hole (not shown in figure) for the bolt 2; as shown in FIG. 8 and FIG. 9, then the gasket 3 is inserted into the clamp gap 71 to be clamped by the clamping part 7, one end (the socket wrench head 6) of the handle 5 is held in hand, the clamping part 7 penetrates through the mounting hole 11 in the lower part of the toilet 1 to drive the gasket 3 to extend into the toilet 1, the position of the bolt 2 can be clearly found through the mounting hole 11, the wrench can be quickly and accurately operated to cause the gasket 3 to be sleeved on the bolt 2, the wrench is pulled back to separate the gasket 3 from the clamp gap 71 and is taken back, and the gasket 3 automatically falls to a lower part of the bolt 2; as shown in FIGS. 10 and 11, next, the nut 4 is placed into the inner cavity 61 inside the socket wrench head 6, the other end (the clamping part 7) or a middle of the handle 5 is held in hand, the wrench is taken sideways to make the socket wrench head 6 horizontal, the nut 4 will not fall off, the socket wrench head 6 penetrates through the mounting hole 11 to drive the nut 4 to extend into the toilet 1, the wrench is turned over to cause the nut 4 to be sleeved on the bolt 2, and the nut 4 is turned with the wrench to be tightened; or as shown in FIGS. 12 to 16, after the nut 4 is sleeved, the wrench is taken back first, a finger is put into the toilet 1 to move the nut 4 to rotate to the lower part of the bolt 2, the wrench is finally put into the toilet, the socket wrench head 6 is sleeved on the nut 4 while the bolt 2 penetrates through the bolt reservation hole 62, and the handle 5 is pulled to tighten the nut 4, thereby completing the mounting of the toilet 1. The present disclosure is suitable for mounting the toilet 1 and other products with narrow and small spaces. Methods for mounting other products may be the same as a method for mounting the toilet 1.

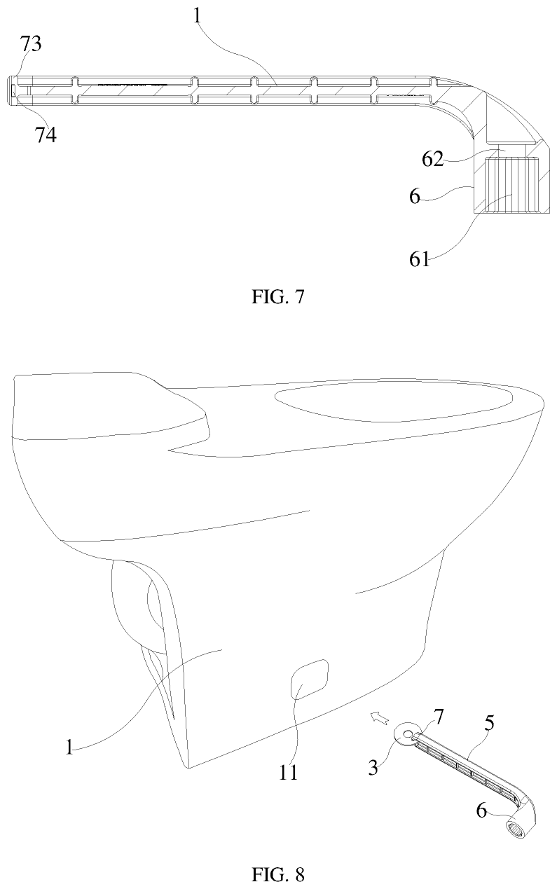

Emphatically referring to FIG. 7, the handle 5 and the socket wrench head 6 are perpendicular to each other in a corner shape. The inner cavity 61 of the socket wrench head 6 needs to place the nut 4, such that the socket wrench head 6 has a certain height. The handle 5 is mainly held in hand and may be set to be thin, making the wrench as a whole compact, reducing the cost, and facilitating the mounting of the gasket 3 and the nut 4.

In addition, the wrench is made of stainless steel or plastics. The stainless steel wrench is sturdy and has a long service life; and the plastic wrench has low cost. If a customer mounts the toilet by himself at home to save the mounting cost and a frequency of mounting the toilet 1 is low, the plastic wrench with low cost is preferred. In addition, manufacturers can also produce plastic wrenches to be sold with toilets, which can better meet the requirements of customers for saving the mounting costs.

The above descriptions are only preferred embodiments of the present disclosure, and are not limitations to the design of the present disclosure. Any equivalent changes made according to the design key points of the present disclosure fall within the scope of protection of the present disclosure.

1. A wrench, comprising a handle and a socket wrench head, wherein the socket wrench head is arranged at one end of the handle, an inner cavity for mounting a nut and a bolt reservation hole in communication with the inner cavity are provided inside the socket wrench head, and a clamping part for clamping a gasket is arranged at a second end of the handle.

2. The wrench according to claim 1, wherein the clamping part is a strip-shaped clamp gap provided at the second end of the handle, and a left clamping arm and a right clamping arm are formed on two sides of the strip-shaped clamp gap.

3. The wrench according to claim 2, wherein a bulge for increasing a clamping force is convexly arranged on a clamping surface of the left clamping arm or the right clamping arm.

4. The wrench according to claim 2, wherein a width of the strip-shaped clamp gap is the same as a thickness of the gasket.

5. The wrench according to claim 2, wherein the left clamping arm and the right clamping arm are made of an elastic material, and a width of the strip-shaped clamp gap is smaller than a thickness of the gasket.

6. The wrench according to claim 1, wherein the inner cavity of the socket wrench head is a quincuncial socket hole.

7. The wrench according to claim 1, wherein the handle and the socket wrench head are perpendicular to each other in a corner shape.

8. The wrench according to claim 1, wherein the wrench is made of stainless steel or plastics.
